(19) United States
(12) Patent Application Publication
(10) Pub. No.: US 2018/0159886 A1
(43) Pub. Date: Jun. 7, 2018

(54) SYSTEM AND METHOD FOR ANALYZING FORENSIC DATA IN A CLOUD SYSTEM

(71) Applicant: Siemens Aktiengesellschaft, München (DE)

(72) Inventors: Jan Gerrit Göbel, Königswinter (DE); Johann Uhrmann, Essenbach (DE)

(73) Assignee: Siemens Aktiengesellschaft, München (DE)

(21) Appl. No.: 15/574,590

(22) PCT Filed: Apr. 14, 2016
(86) PCT No.: PCT/EP2016/058212

§ 371 Date: Nov. 16, 2017

(30) Foreign Application Priority Data
Jun. 2, 2015 (DE) 102015210203.3

(51) Int. Cl. H04L 29/06; H04L 9/32; H04L 9/14; H04L 9/30

(52) U.S. Cl. CPC H04L 63/1433; H04L 9/3226; H04L 63/0442; H04L 9/30; H04L 9/14

(57) ABSTRACT

Disclosed is a system for the analysis of forensic data, wherein the forensic data is present in a cloud system. The system has an analysis unit for analysing the forensic data, wherein the analysis unit is arranged in the cloud system, and has an operating unit for operating the analysis unit, wherein the operating unit is located outside the cloud system remote from the analysis unit. The provided system enables forensic data, which is associated with an IT security incident, to be analysed directly in the cloud system. Thus, extraction of the data from the cloud system or complex transmission of the data to an analysis device is not required. Also disclosed is a method for the analysis of forensic data.

### CROSS-REFERENCE TO RELATED APPLICATIONS

This application claims priority to PCT Application No. PCT/EP2016/058212, having a filing date of Apr. 14, 2016, based off of German application No. DE 102015210203.3 having a filing date of Jun. 2, 2015, the entire contents of both of which are hereby incorporated by reference.

### FIELD OF TECHNOLOGY

The following relates to a system for analyzing forensic data in a cloud system. The following also relates to a method for analyzing forensic data in a cloud system.

### BACKGROUND

In order to analyze and rectify IT security incidents, for example attacks on IT systems by third parties, forensic data are regularly analyzed. These data contain, inter alia, main memory contents (RAM), contents of persistent storage media (hard disks) and recordings of the network traffic of IT systems potentially involved in the security incident.

With the greatly increasing size both of main memories and of persistent memories, the transmission of the data to be analyzed from the affected IT systems to the analysis laboratory is becoming increasingly more complicated. This results, inter alia, in a load on the affected systems with regard to the volume of data to be transmitted and in high utilization of the WAN (Wide Area Network) paths, in particular in the case of networking across different locations.

If the systems to be analyzed are operated by an external provider, for example cloud systems, the transmission of data from the provider's network gives rise to additional transfer costs. If further mass memories are connected to the system to be analyzed, for example via local area networks, they are not captured under certain circumstances when capturing the forensic data of the system to be analyzed and are consequently not evaluated. Furthermore, the data volume of such mass memories is too large to create a copy of it for analysis within the scope of security incidents or to transmit it via networks.

Analysis of the affected system by means of remote access to the affected system may distort the data to be analyzed, may result in a high resource utilization of the system and may provide a possibly still active attacker with indications of ongoing analysis. In addition, the secure deletion of personal data and data otherwise worthy of protection after the analysis has been concluded is no longer ensured on account of the potentially compromised environment.

Forensic data were previously copied to portable data storage media which were then sent by mail for analysis. Alternatively, selected data are requested automatically (software agent) or manually (personnel in situ) for an online check for analysis, in which case data relevant to the analysis may be overlooked here.

For the analysis of connected mass memory systems, the analysts are provided with access data. However, on account of bandwidth restrictions between locations of the analyst and of the system to be analyzed, the analysis is restricted to a small subset of the data which can be accessed.

Network data traffic can be analyzed by means of an infrastructure for recording the data which is already present. Alternatively, an infrastructure, for example a packet sniffer, can be installed or configured. Said problems with regard to completeness and transmission of the volumes of data accordingly apply to the network data traffic.

### SUMMARY

An aspect relates to analyzing forensic data in a simple and secure manner.

Accordingly, a system for analyzing forensic data is proposed, wherein the forensic data are present in a cloud system. The system has an analysis unit for analyzing the forensic data, wherein the analysis unit is arranged in the cloud system, and an operating unit for operating the analysis unit, wherein the operating unit is arranged outside the cloud system in a manner remote from the analysis unit.

According to the proposed apparatus, the analysis unit is moved directly into the vicinity of the IT infrastructure to be examined, that is to say geographically or else with respect to the network topology and the operator. The forensic data can therefore be examined in their original environment and need not be extracted from the latter and transmitted. This makes it possible to prevent distortion of the forensic data since they can be analyzed in their original form. In addition, it is not necessary to transmit the forensic data, for example via a network. This also makes it possible to analyze large volumes of data since possible bandwidth restrictions become irrelevant.

In this context, forensic data can be understood as meaning main memory contents (RAM), contents of persistent storage media (hard disks) and recordings of the network traffic of IT systems potentially involved in the security incident. A security incident can be understood as meaning attacks on IT systems by third parties, that is to say hacker attacks.

In this context, a cloud system or a cloud environment can be understood as meaning a system which has cloud memories and can also be used to host virtual systems and virtual networks.

The analysis unit can analyze these forensic data, that is to say can examine whether these data have been manipulated, for example.

The respective unit, for example the analysis unit or operating unit, can be implemented using hardware and/or else software. In the case of a hardware implementation, the respective unit may be in the form of an apparatus or part of an apparatus, for example in the form of a computer or a microprocessor or a control computer of a vehicle. In the case of a software implementation, the respective unit may be in the form of a computer program product (non-transitory computer readable storage medium having instructions, which when executed by a processor, perform actions), a function, a routine, part of a program code or an executable object.

In this case, the analysis unit is directly located in the cloud system, whereas the operating unit is arranged in a manner remote therefrom, for example at the workstation of an analyst. This relieves the load on the network connections or WAN connections since only small volumes of data in the range of 10 to 30 GB have to be transmitted (from the analysis unit to the operating unit and vice versa) in order to analyze arbitrarily larger systems. As a result of the proximity of the analysis station to mass memory systems, the latter can be used by the analyst like local environments. The restriction to predefined search patterns and the time needed to copy and transmit the data are therefore dispensed with.

According to one embodiment, the operating unit is set up to operate the analysis unit by means of remote access.

The operating unit can provide remote access to the analysis unit by means of a browser, for example. In this case, the operating unit can visualize the analysis unit as a window on a display apparatus, for example a screen, of a computer.

According to another embodiment, the analysis unit is a virtualized analysis unit.

In this case, a virtualized analysis unit is understood as meaning an analysis unit which is arranged, that is to say stored, in the cloud system as a virtualized variant of an analysis unit physically present in situ.

According to another embodiment, the analysis unit is based on a model.

Providing a corresponding model makes it possible to install this analysis unit within a few minutes. In this case, a model can also be referred to as an image. The one-off provision of models for analysis units and the system analysis in cloud environments avoid the need to transfer the data to be analyzed from the provider's system environment for a fee.

According to another embodiment, the analysis unit is set up to store storage units of the cloud system, which contain the forensic data to be analyzed, as a local copy.

The data memories to be examined can be connected to the analysis unit by means of corresponding configuration of the analysis unit as a local copy.

According to another embodiment, the analysis unit is set up to directly incorporate storage units of the cloud system, which contain the forensic data to be analyzed.

This makes it possible for the analysis unit to directly access the storage units without having to additionally locally store the latter. In this case, the analysis unit can incorporate (mount) the storage units as its own storage units and can access them.

According to another embodiment, the analysis unit is set up to locally store the forensic data to be analyzed in an encrypted storage area.

Since the relevant data are stored in an encrypted storage area, a possibly still active attacker cannot access them. The key can be randomly generated for each analysis.

According to another embodiment, the analysis unit and the operating unit are set up to communicate by means of asymmetric authentication.

All identifiers of the analyst which are transmitted between the operating unit and the analysis unit can use a public/private key method for authentication. Since there are no password-protected access operations, the security with respect to an attacker is increased since the latter cannot tap any passwords.

According to another embodiment, the analysis unit is set up to communicate with predefined units.

In order to increase the security of the analysis unit and therefore the security of the analysis of the forensic data, that is to say the protection against manipulations, the reachability of the analysis unit can be restricted to a defined list of devices. Therefore, any desired devices, for example belonging to an attacker, cannot access the analysis unit and cannot endanger or manipulate the analysis of the data.

According to another embodiment, the analysis unit has restricted visibility in the cloud system.

This can be effected, for example, by using a firewall. This further increases the security of the analysis unit.

As a result of the encryption of the data to be analyzed and the minimal visibility in the network, no information relating to the ongoing analysis is available to a possibly active attacker. The encryption of the analysis data likewise allows the complete analysis station to be deleted without information relating to the data which can be used by third parties remaining in the system environment.

According to another embodiment, the analysis unit is set up to monitor network traffic in the cloud system.

According to this embodiment, local network traffic can be recorded in the cloud system. This makes it possible to analyze the network data traffic in real time.

A method for analyzing forensic data is also proposed, wherein the forensic data are present in a cloud system. The method has the following steps of: analyzing the forensic data in an analysis unit, wherein the analysis unit is arranged in the cloud system, and operating the analysis unit by means of an operating unit, wherein the operating unit is arranged outside the cloud system in a manner remote from the analysis unit.

The embodiments and features described for the proposed apparatus accordingly apply to the proposed method.

A computer program product which causes the method explained above to be carried out on a program-controlled device is also proposed.

A computer program product, for example a computer program means, may be provided or delivered, for example, as a storage medium, for example a memory card, a USB stick, a CD-ROM, a DVD, or else in the form of a downloadable file from a server in a network. This can be effected, for example in a wireless communication network, by transmitting a corresponding file containing the computer program product or the computer program means.

Further possible implementations of embodiments of the invention also comprise combinations (not explicitly mentioned) of features or embodiments described above or below with respect to the exemplary embodiments. In this case, a person skilled in the art will also add individual aspects as improvements or additions to the respective basic form of embodiments of the invention.

Embodiments of the invention are explained in more detail below on the basis of preferred embodiments with reference to the enclosed figures.

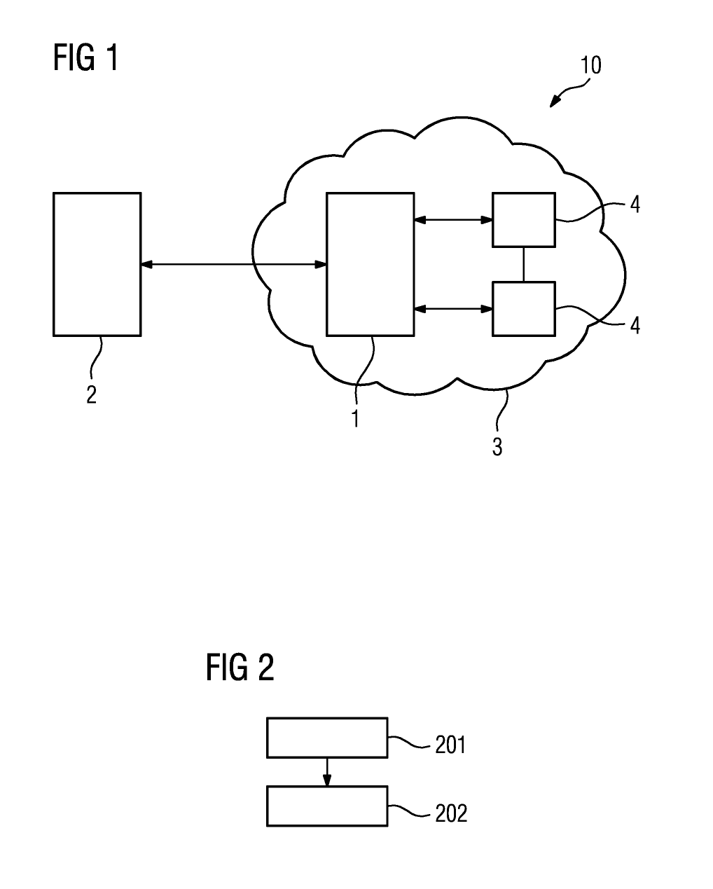

FIG. 1 shows a schematic block diagram of one embodiment of a system for analyzing forensic data; and

FIG. 2 shows a schematic flowchart of a method for analyzing forensic data.

### BRIEF DESCRIPTION

Some of the embodiments will be described in detail, with reference to the following figures, wherein like designations denote like members, wherein:

FIG. 1 shows a system for analyzing forensic data, in accordance with embodiments of the present invention; and

FIG. 2 shows a method for analyzing forensic data, in accordance with embodiments of the present invention.

### DETAILED DESCRIPTION

FIG. 1 shows a system for analyzing forensic data, in accordance with embodiments of the present invention. In this case, the forensic data are present in a cloud system 3, for example in various storage units or computer units 4.

The system 10 has an analysis unit 1 for analyzing the forensic data. In this case, the analysis unit 1 is directly arranged in the cloud system 3. In this manner, the analysis unit 1 can directly access the data in the cloud system 3. For this purpose, the analysis unit 1 can incorporate the storage units 4, for example.

The analysis unit 1 can be operated by an analyst using an operating unit 2 which is arranged outside the cloud system 3 in a manner remote from the analysis unit 1. This can be effected using remote access, for example.

The analysis unit 1 can therefore directly examine the forensic data at their origin in the cloud system 3.

FIG. 2 shows a method for analyzing forensic data. The method has the following steps.

In step 201, the forensic data are analyzed in the analysis unit 1, the analysis unit 1 being arranged in the cloud system 3.

In step 202, the analysis unit 1 is operated using the operating unit 2, the operating unit 2 being arranged outside the cloud system 3 in a manner remote from the analysis unit 1.

Steps 201 and 202 can be carried out at the same time or in a different order.

Although the present invention has been described on the basis of exemplary embodiments, it can be modified in various ways.

1. A system for analyzing forensic data, wherein the forensic data are present in a cloud system, the system comprising:
an analysis unit for analyzing the forensic data, wherein the analysis unit is arranged in the cloud system; and
an operating unit for operating the analysis unit, wherein the operating unit is arranged outside the cloud system in a manner remote from the analysis unit.

2. The system as claimed in claim 1, wherein the operating unit is set up to operate the analysis unit by means of remote access.

3. The system as claimed in claim 1, wherein the analysis unit is a virtualized analysis unit.

4. The system as claimed in claim 1, wherein the analysis unit is based on a model.

5. The system as claimed in claim 1, wherein the analysis unit is set up to store storage units of the cloud system, which contain the forensic data to be analyzed, as a local copy.

6. The system as claimed in claim 1, wherein the analysis unit is set up to directly incorporate storage units of the cloud system, which contain the forensic data to be analyzed.

7. The system as claimed in claim 1, wherein the analysis unit is set up to locally store the forensic data to be analyzed in an encrypted storage area.

8. The system as claimed in claim 1, wherein the analysis unit and the operating unit are set up to communicate by means of asymmetric authentication.

9. The system as claimed in claim 1, wherein the analysis unit is set up to communicate with predefined units.

10. The system as claimed in claim 1, wherein the analysis unit has restricted visibility in the cloud system.

11. The system as claimed in claim 1, wherein the analysis unites is set up to monitor network traffic in the cloud system.

12. A method for analyzing forensic data, wherein the forensic data are present in a cloud system, comprising:
analyzing the forensic data in an analysis unit, wherein the analysis unit is arranged in the cloud system, and
operating the analysis unit by means of an operating unit, wherein the operating unit is arranged outside the cloud system in a manner remote from the analysis unit.

13. A computer program product, comprising a computer readable hardware storage device having computer readable program code stored therein, said program code executable by a processor of a computer system to implement a method for analyzing forensic data as claimed in claim 12 to be carried out on a program-controlled device.
